(19) United States
(12) Patent Application Publication
(10) Pub. No.: US 2013/0129409 A1
(43) Pub. Date: May 23, 2013

(54) DEVICE AND METHOD FOR JOINING A COMPOSITE AND METALLIC MATERIAL

(71) Applicants: Jeong Min Cho, Uiwang (KR); Young Ho Choi, Seongnam (KR)

(72) Inventors: Jeong Min Cho, Uiwang (KR); Young Ho Choi, Seongnam (KR)

(73) Assignee: HYUNDAI MOTOR COMPANY, Seoul (KR)

(21) Appl. No.: 13/366,626

(22) Filed: Feb. 6, 2012

(30) Foreign Application Priority Data
Nov. 23, 2011 (KR) 10-2011-0122703

(51) Int. Cl. F16B 11/00; F16B 17/00; B32B 37/12

(52) U.S. Cl. 403/266; 156/91; 403/376

(57) ABSTRACT

Disclosed is a device and method for joining a composite and a metallic material which can stably join a composite and a metallic plate while improving the joint strength thereof. The device includes a fastening end formed at the center of the end face of the first joint end of the composite to protrude integrally, and a fastening slot formed at the center of the end face of the second joint end of the metallic material. The fastening end of the composite is fitted and fastened in the fastening slot of the metallic material, a female screw is inserted along the thickness direction through the fitted and fastened part between the fastening end and the fastening slot, and a male screw is fitted in and fastened to the female screw.

### CROSS-REFERENCE TO RELATED APPLICATION

This application claims under 35 U.S.C. §119(a) the benefit of Korean Patent Application No. 10-2011-0122703 filed on Nov. 23, 2011, the entire contents of which are incorporated herein by reference.

### BACKGROUND

(a) Technical Field

The present invention relates to a device and method for joining a carbon fiber/polymer composite and a metallic material. More particularly, the present invention relates to a device and method for joining a carbon fiber/polymer composite and a metallic material which can stably join a carbon fiber/polymer composite and a metallic plate while improving the joint strength thereof.

(b) Background Art

A conventional joint between a carbon fiber/polymer composite and a metallic material may be classified into i) single-lap joint, ii) double-lap joint, and iii) joint with attachments or the like in accordance with the shape of the joint. In such joints, an adhesively bonded joint method, and a hybrid joint method using an adhesive and bolts in unison are applied.

The single-lap joint is a method of overlapping an end of a carbon fiber composite and an end of a metallic material and then joining the ends with an adhesive or a bolt/nut as shown in FIG. 5. The double-lap joint is a method of arranging a carbon fiber composite and a metallic material in such a manner that the ends thereof are opposite to each other, adding carbon fiber composites on the top and bottom of the ends, and adhesively bonding the carbon fiber composites to the ends as shown in FIG. 6. The joint with attachments is a method of overlapping and joining the ends of a carbon fiber composite and a metallic material with an adhesive, adding reinforcement plates on the top and bottom of the ends, and joining the reinforcement plates to the ends with an adhesive or a bolt/nut as shown in FIG. 7.

However, the conventional joint methods as described above commonly have a disadvantage in that since stresses are concentrated on the joint point between the ends of the carbon fiber composite and the metallic material, the joint strength is poor. That is, as can be seen from the circled parts in FIGS. 8 and 9 showing the mechanical stress distribution graphs of single-lap and double-lap joint methods, the single-lap and double-lap joint methods both have a concentration of detachment stresses existing at the joint point between the ends of the carbon fiber composite and the metallic material, and due to such stress concentration, the joint strength of the heterogeneous materials is reduced.

Considering the above-mentioned disadvantages, it is possible to increase the joint strength by adding reinforcements, such as bolt/nut or one or more reinforcement plates to the joint parts formed through the single-lap and double-lap joint methods, in which the reinforcements serve as a kind of safety means (a fail-safe structure) which copes with abrupt fractures. However, the attachment of the above-mentioned reinforcements does not greatly relieve the stress concentration.

That is, for example, the bolt/nut, which is a kind of reinforcement, has a disadvantage in that since the head and threads of the bolt are in contact with the carbon fiber composite and do not have a high ultimate strain when a compressive force is applied, fractures may be initiated from the carbon fiber composite.

In addition, in the above mentioned joint methods, since the ends of the carbon fiber composite and the metallic material are overlapped with each other at different heights, the joint part is not seen as externally natural. Thus, its aesthetic appeal is significantly decreased.

The above information disclosed in this background section is only for enhancement of understanding of the background of the invention and therefore it may contain information that does not form the prior art that is already known in this country to a person of ordinary skill in the art.

### SUMMARY OF THE DISCLOSURE

The present invention provides a device and method of joining a carbon fiber/polymer composite and a metallic material, which can enhance joint strength and stability through an effective joint design for joining a composite, e.g., carbon fiber/polymer and a metallic plate, and can provide an externally natural joint form.

In one aspect, the present invention provides a device for joining a first joint end, which is an end of a carbon fiber/polymer composite, and a second joint end, which is an end of a metallic material, the device including: a fastening end formed at the center of the end face of the first joint end of the carbon fiber/polymer composite to protrude integrally; and a fastening slot formed at the center of the end face of the second joint end of the metallic material. The fastening end of the carbon fiber/polymer composite is fitted and fastened in the fastening slot of the metallic material, a female screw is inserted along the thickness direction through the joint part between the fastening end and the fastening slot, and a male screw is fitted in and fastened to the female screw.

In an exemplary embodiment, the fastening end of the carbon fiber/polymer composite and the fastening slot are bonded to each other by an adhesive.

In another exemplary embodiment, the end face of the first joint end of the carbon fiber/polymer composite is formed to be inclined to the fastening end at a predetermined angle (θ), and the end face of the second joint end is also formed to be inclined to the fastening slot at the same angle (θ).

In still another exemplary embodiment, the end face of the first joint end of the carbon fiber/polymer composite is formed to be inclined to the fastening end at an angle in the range of 45°≦θ<90°, and the end face of the second joint end of the metallic material is also formed to be inclined at an angle in the range of 45°≦θ<90°.

In another aspect, the present invention provides a method for joining a first joint end, which is an end of a carbon fiber/polymer composite, and a second joint end, which is an end of a metallic material, the method including: forming a fastening end at the center of the end face of the first joint end of the carbon fiber/polymer composite to protrude integrally, and forming a fastening slot at the center of the end face of the second joint end of the metallic material. The first joint end of the carbon fiber/polymer composite including the fastening end, and the second joint of the metallic material including the fastening slot is then cleaned and a silane primer is coated on the surface of the cleaned fastening slot. Next, an adhesive is coated on the silane primer-coated fastening slot and the fastening end, and then fitted to fasten the fastening end in the fastening slot. a female screw is inserted along the thickness direction through the joint part between the fastening end and the fastening slot. Finally, a male screw is fit in the female screw, and the adhesive is allowed to cure in an oven.

In yet another exemplary embodiment, the carbon fiber/polymer composite is formed by mixing continuously extending carbon fibers and epoxy, and the metallic material is formed from an aluminum material.

In still yet another exemplary embodiment, the adhesive is a mixture formed by mixing a DGEBA (Diglycidyl Ether of Bisphenol-A) resin and an amine hardener in a weight ratio of 100:25.

Through the above-mentioned features, the present invention provides following effects.

In accordance with the present invention, in order to join a carbon fiber/polymer composite and a metallic material, the shape of each of the joint ends of the carbon fiber/polymer composite and the metallic material are designed as a efficient joint structure, and the joint ends of the carbon fiber/polymer composite and the metallic material are joined to each other through a first joining step for fitting and fastening the joint ends with each other using an adhesive, and a second joining step using a female screw and a male screw, whereby the joint strength between the composite and the metallic material can be stably improved, and hence it is possible to prevent the joint strength between the composite and the metallic material from being deteriorated due to the concentration of detachment and shear stresses.

In addition, since the joint part between the carbon fiber/polymer composite and the metallic material forms a linear construction, the joint part can be smoothly formed thereby being improved in terms of aesthetic external appearance.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is a cross-sectional view showing a device for joining a carbon fiber/polymer composite and a metallic material in accordance with an exemplary embodiment of the present invention;

FIGS. 2a and 2b are cross-sectional views showing a device in accordance with an embodiment of an exemplary embodiment of the present invention and a conventional joint device in comparison;

FIGS. 3 and 4 are graphs showing results of testing stress concentration and shearing stress of the inventive device and a comparative joint device;

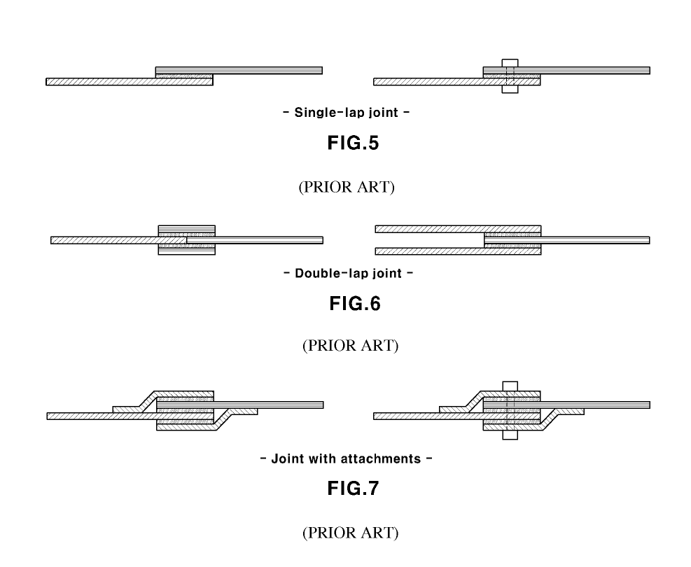

FIGS. 5 to 7 are schematic views showing conventional joint devices; and

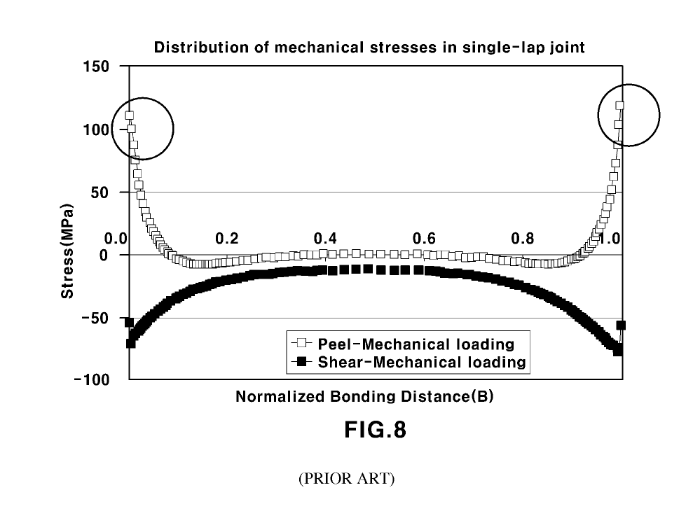

FIGS. 8 and 9 are graphs for describing stress distributions for conventional joint devices.

### DETAILED DESCRIPTION

Hereinafter, exemplary embodiments of the present invention will be described with reference to the accompanying drawings so that those skilled in the art can easily carry out the invention.

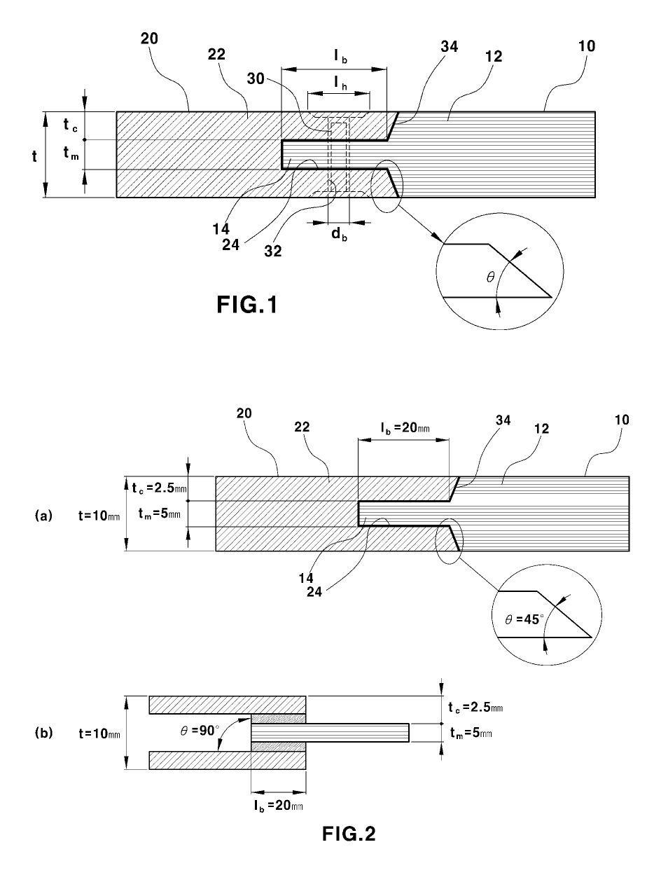

As shown in FIG. 1, the present invention fits and fastens a carbon fiber/polymer composite and a metallic plate with each other to form a linear structure in joining a carbon fiber/polymer composite and a metallic plate with each other. That is, by adopting a method of fitting and fastening a first joint end 12, which is one end of the carbon fiber/polymer composite 10, and a second joint end 22, which is one end of the metallic material 20, with each other, the present invention increases the joint strength of the composite and the metallic material, and by making the joint part form a linear structure. The present invention also improves the aesthetic external appearance of the joint part.

For this purpose, an optimized size design is made for fitting and fastening the first joint end 12, which is one end of the carbon fiber/polymer composite 10, and the second end 22, which is one end of the metallic material 20, and the first and second joints are precisely machined on the basis of size design in such a manner that a fastening end 14 is formed to integrally protrude from the center of the end face of the first joint end 12 of the carbon fiber/polymer composite 10, and a fasting slot 24 is formed at the center of the end face of the second joint end 22 of the metallic material 20 to receive the fastening end 14.

Illustratively, the carbon fiber/polymer composite 10 is formed by mixing continuously extending carbon fibers and epoxy, and the metallic material 20 is formed from an aluminum 6061-T6 material.

In particular, in order to increase the adhesive coating area between the first joint end 12 of the carbon fiber/polymer composite 10 and the second joint end 22 of the metallic material 20, and to relieve the stress concentration in the adhesive layer, thereby increasing the bond strength, the end face of the first joint end 12 of the carbon fiber/polymer composite 10 is formed to be inclined to the fastening end 14 at a predetermined angle (θ), and the end face of the second joint end 22 of the metallic material 20 is also formed to be inclined to the fastening slot 24 at the same angle (θ).

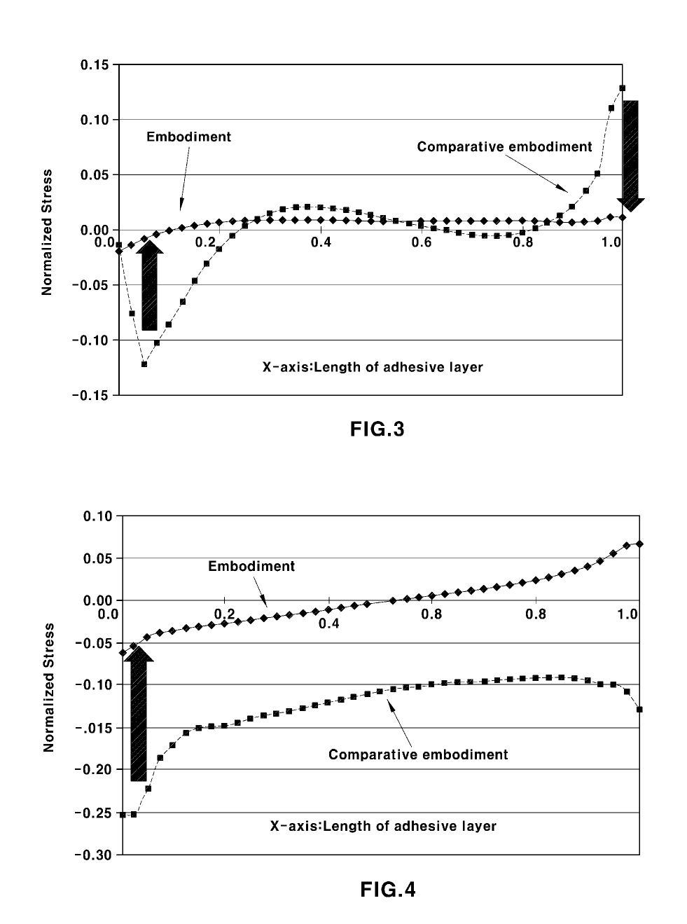

Preferably, the end face of the first joint end 12 of the carbon fiber/polymer composite 10 is formed to be inclined to the fastening end 14 at an angle in the range of 45°≦θ<90°, and the end face of the second joint end 22 of the metallic material 20 is also formed to be inclined at an angle in the range of 45°≦θ<90°. An example of size design for the first joint end 12 of the carbon fiber/polymer composite 10 and the second joint end 22 of the metallic material 20 is shown in FIG. 2.

Next, prior to coating an adhesive 34 on the end face of the first joint end 12 including the fastening end 14 of the carbon fiber/polymer composite 10 and on the end face of the second joint end 22 including the fastening slot 24 of the metallic material 20, a cleaning step and a silane primer coating step are performed in order to facilitate the bonding by the adhesive 34.

That is, prior to coating the adhesive, the end face of the first joint end 12 including the fastening end 14 of the carbon fiber/polymer composite 10 and the end face of the second joint end 22 including the fastening slot 24 are cleaned using a solvent, and the cleaned surface of the fastening slot 24 is coated with a silane primer (a solution formed by adding 1% silane liquid to neutral purified water).

Next, the adhesive 34 is coated on the end face of the first joint end 12 including the cleaned fastening end 14 and the end face of the second joint end 22 including the silane primer coated fastening slot 24. The fastening end 14 is fitted in and fastened to the fastening slot 24.

At this time, a mixture formed by mixing, e.g., a DGEBA (Diglycidyl Ether of Bisphenol-A) resin and an amine hardener in a weight ratio of 100:25 is used as the adhesive 34 and applying it accordingly to the end face of the first joint end 12 including the cleaned fastening end 14 and the end face of the second joint end 22 including the silane primer coated fastening slot 24. As a result, the first joint end 12 of the carbon fiber/polymer composite 10 and the second joint end 22 of the metallic material 20 are primarily bonded to each other by the adhesive 34. That is, the fastening end 14 and the fastening slot 24 are primarily bonded by the adhesive 34 simultaneously when the fastening end 14 of the carbon fiber/polymer composite 10 is fitted in the fastening slot 24.

As the end face of the first joint end 12 and the end face of the second joint end 22 are formed to be inclined in the range of 45°≦θ<90°, the stress concentration in the adhesive layer is relieved, and the adhesive coating area is increased, whereby the bonding strength can be improved.

Next, a secondary fastening step is performed in which the first joint end 12 of the carbon fiber/polymer composite 10 and the second joint end 22 of the metallic material 20 are fastened with each other by a female screw 30 and a male screw 32. More specifically, the female screw 30 is inserted from one side of the second joint end 22 formed with the fastening slot 24 of the metallic material 20 to the opposite side of the second joint end 22 through the joint end 14, and then the male screw 32 is inserted into and fastened to the female screw 30 in the direction opposite to the fastening direction of the female screw, thereby completing the secondary bonding step for secondarily fastening the first joint end 12 of the carbon fiber/fiber composite 10 and the second joint end 22 of the metallic material 20 with each other by the female screw 30 and the male screw 32.

Finally, the carbon fiber/polymer composite 10 and the metallic material 20 joined to each other by the adhesive 34, the female screw 30 and the male screw 32 are put into an oven to cure the adhesive 34.

Now, the present invention will be described in more detail through an embodiment and a comparative embodiment.

### Example

As described above, the fastening end 14 of the first joint end 12 of the carbon fiber/polymer composite 10 is primarily fitted in and fastened to the fastening slot 24 of the second joint end 22 of the metallic material 20 using an adhesive, and secondarily fastened to each other by using the female screw 30 and the male screw 32, in which as shown in FIG. 2a, the designed sizes for joint are as follow: t=10 mm, tₘ=5 mm, t_{c}=2.5 mm, l_{b}=20 mm, lₕ=0 mm, d_{b}=0 mm, and θ=45°

### Comparative Example

A comparative example is prepared in the existing double-lap joint type, in which as shown in FIG. 2b, the designed sizes for joint are as follow: t=10 mm, tₘ=5 mm, t_{c}=2.5 mm, l_{b}=20 mm, lₕ=0, d_{b}=0, and θ=90°.

### Test Example

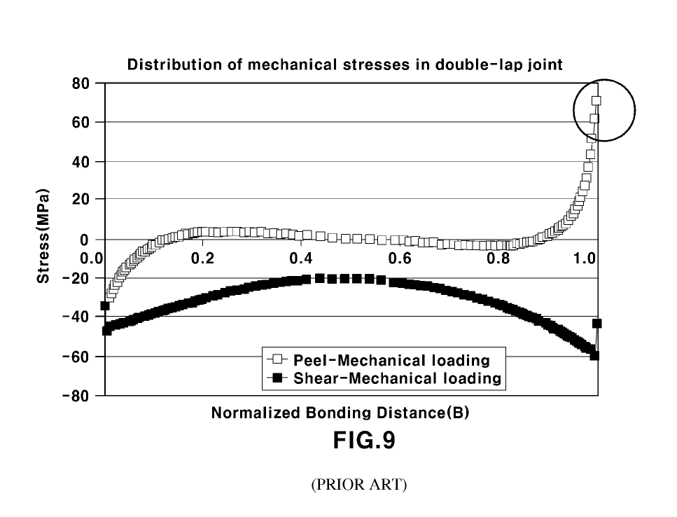

The concentration degrees of peeling stresses and shear stresses for the inventive joint structures and double-lap joint structures, i.e. the concentration degrees of peeling stresses and shear stresses produced in the adhesive layers under a tension load were measured, and the text results are shown in FIGS. 8 and 9.

As can be seen from FIGS. 8 and 9, the inventive joint structures exhibit a concentration degree of peeling stresses lowered by approximately 10 times, and a concentration degree of shear stresses lowered by approximately 5 times, as compared to those of the comparative example.

It can be appreciated that the inventive joint structure exhibits substantially lower concentrations of peeling stresses and shear stresses as mechanical compressive forces are added due to the fastening of the female screw and the male screw, and consequently, due to the bonding strength provided by the adhesive and the fastening strength provided by the female and male screws, the inventive joint structure is improved in terms of entire bonding strength and fastening strength as compared to the conventional joint structure in accordance with the comparative example.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A device for joining a first joint end, which is an end of a composite, and a second joint end, which is an end of a metallic material, the device comprising:
a fastening end formed at the center of an end face of the first joint end of the composite to protrude integrally; and
a fastening slot formed at the center of an end face of the second joint end of the metallic material,
wherein the fastening end of the composite is fitted in and fastened to the fastening slot of the metallic material, a female screw is inserted along the thickness direction through the joint part between the fastening end and the fastening slot, and a male screw is fitted in and fastened to the female screw.

2. The device of claim 1, wherein the fastening end of the composite and the fastening slot are bonded to each other by an adhesive.

3. The device of claim 1, wherein the end face of the first joint end of the composite is formed to be inclined to the fastening end at a predetermined angle (θ), and the end face of the second joint end is also formed to be inclined to the fastening slot at the same angle (θ).

4. The device of claim 3, wherein the end face of the first joint end of the composite is formed to be inclined to the fastening end at an angle in the range of 45°≦θ<90°, and the end face of the second joint end of the metallic material is also formed to be inclined at an angle in the range of 45°≦θ<90°.

5. A method for joining a first joint end, which is an end of a composite, and a second joint end, which is an end of a metallic material, the method comprising:
forming a fastening end at the center of an end face of the first joint end of the composite to protrude integrally, and forming a fastening slot at the center of an end face of the second joint end of the metallic material;
cleaning the first joint end of the composite including the fastening end, and the second joint of the metallic material including the fastening slot;
coating a silane primer on the surface of the cleaned fastening slot;
coating an adhesive on the silane primer-coated fastening slot and then fitting and fastening the fastening end in the fastening slot;
inserting a female screw along the thickness direction through the fitted and fastened part between the fastening end and the fastening slot;
fitting and fastening a male screw in the female screw; and
curing the adhesive in an oven.

6. The method of claim 5, wherein the composite is formed by mixing continuously extending carbon fibers and epoxy, and the metallic material is formed from an aluminum material.

7. The method of claim 5, wherein the adhesive is a mixture formed by mixing a DGEBA (Diglycidyl Ether of Bisphenol-A) resin and an amine hardener in a weight ratio of 100:25.

8. A device for joining a first joint end, which is an end of a composite, and a second joint end, which is an end of a metallic material, the device comprising:
a fastening end formed at the center of an end face of the first joint end of the composite to protrude integrally; and
a fastening slot formed at the center of an end face of the second joint end of the metallic material,
wherein the fastening end of the composite is fitted in and fastened to the fastening slot of the metallic material.

9. The device of claim 8, wherein a female screw is inserted along the thickness direction through the joint part between the fastening end and the fastening slot, and a male screw is fitted in and fastened to the female screw

10. The device of claim 8, wherein the fastening end of the composite and the fastening slot are bonded to each other by an adhesive.

11. The device of claim 8, wherein the end face of the first joint end of the composite is formed to be inclined to the fastening end at a predetermined angle (θ), and the end face of the second joint end is also formed to be inclined to the fastening slot at the same angle (θ).

12. The device of claim 11, wherein the end face of the first joint end of the composite is formed to be inclined to the fastening end at an angle in the range of 45°≦θ<90°, and the end face of the second joint end of the metallic material is also formed to be inclined at an angle in the range of 45°≦θ<90°.

13. The device of claim 8, wherein the composite is a carbon fiber or polymer composite.

14. A method for joining a first joint end, which is an end of a composite, and a second joint end, which is an end of a metallic material, the method comprising:
forming a fastening end at the center of an end face of the first joint end of the composite to protrude integrally, and forming a fastening slot at the center of an end face of the second joint end of the metallic material;
coating a primer on the surface of the fastening slot;
coating an adhesive on the primer-coated fastening slot and then fitting and fastening the fastening end in the fastening slot;
inserting a female screw along the thickness direction through the fitted and fastened part between the fastening end and the fastening slot;
fitting and fastening a male screw in the female screw; and
curing the adhesive in an oven.

15. The method of claim 14, wherein the composite is formed by mixing continuously extending carbon fibers and epoxy, and the metallic material is formed from an aluminum material.

16. The method of claim 14, wherein the adhesive is a mixture formed by mixing a DGEBA (Diglycidyl Ether of Bisphenol-A) resin and an amine hardener in a weight ratio of 100:25.
